(19) United States
(12) Patent Application Publication
(10) Pub. No.: US 2014/0359777 A1
(43) Pub. Date: Dec. 4, 2014

(54) CONTEXT-AWARE RISK MEASUREMENT MOBILE DEVICE MANAGEMENT SYSTEM

(71) Applicant: Fixmo, Inc., Toronto (CA)

(72) Inventors: Wing Young Lam, Markham (CA); Chun Fung Yuen, Mississauga (CA); Richard Segal, Toronto (CA)

(21) Appl. No.: 13/906,893

(22) Filed: May 31, 2013

(51) Int. Cl. G06F 21/57

(52) U.S. Cl. CPC G06F 21/577
USPC 726/25

(57) ABSTRACT

A mobile device management server and method are provided for determining the security risk for deployed mobile devices. The mobile device management server receives risk measurements from mobile devices that are used to calculate a risk score based on rules. The risk score can also be adjusted by correlating the received risk measurements with past security breaches or typical usage measurements. The calculated risk score is compared to a one or more thresholds to determine whether to take a protective action that is associated with exceeding a threshold.

### FIELD

The present disclosure relates generally to managing deployed mobile devices. More particularly, the disclosure relates to mobile device management systems.

### BACKGROUND

Mobile device management (MDM) software is used to secure, monitor, manage and support mobile devices that are deployed across mobile operators, service providers and enterprise. Mobile devices can include smartphones, tablets and other mobile computing devices. Traditional MDM technologies can help organizations distribute software to mobile devices, configure policies and security settings, automate tasks related to asset management and support, and issue commands to lock, wipe or control devices remotely. While MDM helps organizations manage device inventory and mitigate risks associated with lost or stolen devices, they do not address the broader sets of security and privacy risks associated with mobile devices. These privacy and security risks not addressed by traditional MDM technology include those risks associated with mobility infrastructure, mobile devices and their applications, the end-users themselves and external physical threats as well as situational risk due to the ever-changing state of the surrounding environment.

Security and privacy risks can be dynamic and change based on the physical environment or software environment that are not addressed by traditional MDM technology. Some of these risks can arise from running compromised software on the mobile device. This can include running a vulnerable operating system or an operating system that has undergone a successful privilege escalation attack. Privilege escalation is the act of exploiting a bug, design flaw or configuration oversight in an operating system or software application to gain elevated access to resources that are normally protected from an application or user. This results in more privileges than intended by the application developer or system administrator. Other software risks can include the presence of malware or applications that are untrusted or vulnerable to a malware exploit. Security and privacy risks can also arise from connections to networks or peripherals that are insecure or untrusted. For example, this could include roaming onto an untrusted network or connecting an insecure Bluetooth device. There are also security risks associated with access privileges to information either located on the mobile device or accessible by the mobile device. Other security and privacy risks can be associated with policy configurations of the mobile devices, end-user behavior or cyber attacks on the mobile device or related network resources. Many of these security and privacy risks are dynamic and change with the context of the mobile device, but traditional MDM software does not consider these aspects which results in an inefficient security mechanism from the perspective of both device users and administrators of the mobile device deployment.

Traditional MDM software does not take into account all of these security risks to determine the security or privacy risk of a deployed mobile device. Instead policies and granular rules are defined during provisioning of the mobile device that is used to restrict or allow functionality of the mobile device. These policies and rules are typically permissions and can include whitelists and blacklists. These policies and rules do not take into account all security and privacy risks of the mobile device, especially those that are dynamic, when applying the policy or rule. Implementation of granular policies can also be overly restrictive by unduly limiting the operation of the mobile device because a policy only considers a single factor and does not consider the overall risk of the operational environment or device context as a whole.

### SUMMARY

According to a first aspect, there is provided a method for determining security risk of a mobile device that comprises receiving risk measurements from at least one mobile device; calculating a risk score by evaluating the risk measurements based on rules; determining whether the calculated risk score exceeds a threshold; and taking a protective action upon the risk score exceeding the threshold. Calculating the risk score can further include correlating the risk measurements with a past security breach that can be associated with historical risk measurements. Calculating the risk score can also include correlating the received risk measurements with typical usage risk measurements that can be obtained by periodically storing risk measurements from the deployed mobile devices. The protective action can include a sending an administrator notification and sending a protective management command to the mobile device. The protective management command can instruct the mobile device to prevent access to privileged information. It can also instruct a user access privilege server to disable network access to privileged information from the mobile device. The protective management command can also instruct the mobile device to delete data or a user access privilege server to disable a user account associated with the mobile device. In some aspects, the a portion of the risk measurements can be collected from a user access privileges server that can include a job title of the user of the mobile device.

According to another aspect, there is provided a method for determining security risk of a mobile device that comprises obtaining risk measurements from mobile device sensors; and transmitting the risk measurements to a mobile device management server. In some aspects, the method can further comprise detecting a change in at least one of the risk measurements and wherein transmitting the risk measurements upon detecting the change. In other aspects, the method can further comprise receiving a protective management command in response to transmitted risk measurement that instructs the mobile device to limit access to privileged information. The mobile device sensors can include hardware or software sensors and can be used to collect static and dynamic risk measurements. Static risk measurements can include comprise any one of: installed applications; installed application permissions; author signing key of installed applications; operating system version; user identification; and malware indicators. Dynamic risk measurements can include any one of: network connections; available memory; CPU temperature; GPS location; current roaming carrier, currently running applications; current date and time; and information privileges of a user of the mobile device.

According to yet another aspect, there is provided a method for providing mobile device security that comprises receiving a timeout rule that specifies a timeout period and a protective action from a mobile device management server; attempt to contact the mobile device management server within the timeout period; and perform the protective action upon failure to contact the mobile device management server within the timeout period. In some aspects, the timeout rule can be received during provisioning of the mobile device.

### BRIEF DESCRIPTION OF THE DRAWINGS

For a better understanding of the various embodiments described herein and to show more clearly how they may be carried into effect, reference will now be made, by way of example only, to the accompanying drawings which show at least one exemplary embodiment, and in which:

FIG. 1 is a block diagram showing illustrating a mobile device management server managing a plurality of mobile devices;

FIG. 2 is a block diagram of a mobile device management server configured to calculate a risk score based on number of risk measurements;

FIG. 3 is a flow chart of a method for determining a security risk of a mobile device; and

FIG. 4 is a block diagram of an embodiment of a computing device capable of implementing the systems and methods described herein.

### DESCRIPTION OF VARIOUS EMBODIMENTS

It will be appreciated that for simplicity and clarity of illustration, where considered appropriate, numerous specific details are set forth in order to provide a thorough understanding of the exemplary embodiments described herein. However, it will be understood by those of ordinary skill in the art that the embodiments described herein may be practiced without these specific details. In other instances, well-known methods, procedures and components have not been described in detail so as not to obscure the embodiments described herein. Furthermore, this description is not to be considered as limiting the scope of the embodiments described herein in any way, but rather as merely describing the implementations of various embodiments described herein.

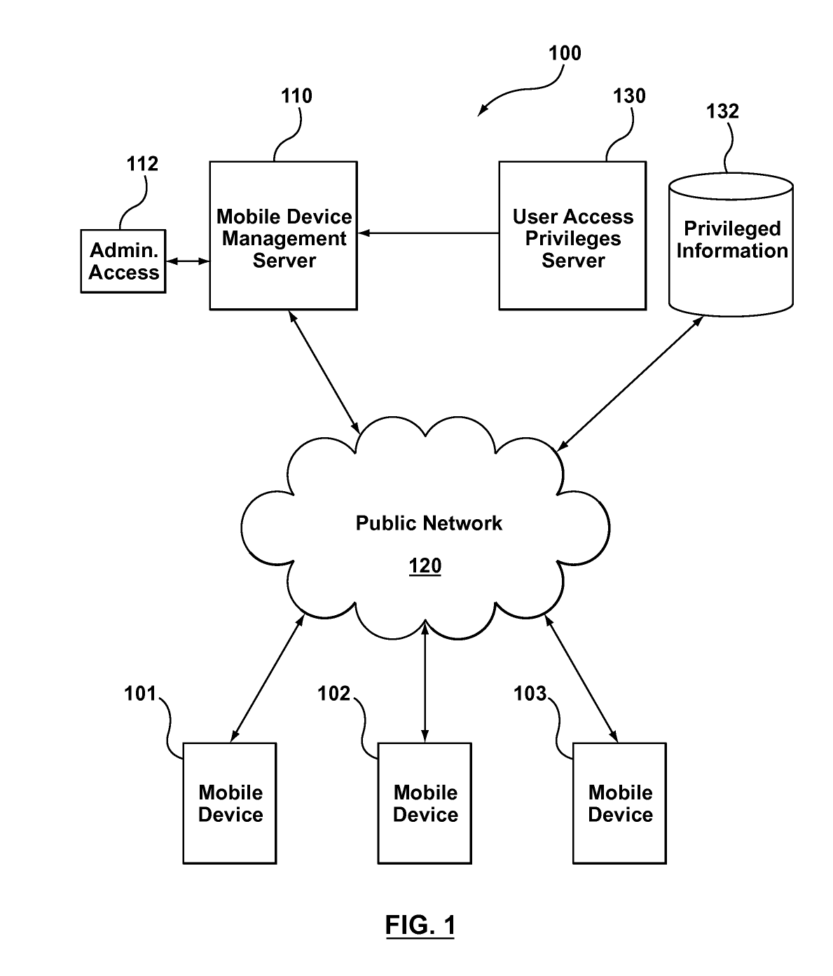

Referring now to FIG. 1, shown is a block diagram of a mobile device management system 100 that can be used to implement one or more embodiments as further described below. A mobile device management server 110 is coupled, either directly or indirectly, to managed mobile devices 101-103 through network 120. Network 120 can include the public internet, a cellular telephone network, a wide area network, a local area network, and other known networks or any combination thereof. Network 120 is used to route data between mobile devices 101-103 and mobile device management server 110. Network 120 can also include virtual local area networks, broadcast domains or virtual private network tunnels that can be provided over public or private networks.

Mobile devices 101-103 are preferably handheld or portable computing devices that have a processor, a memory, a display and an input/output system that can include an input interface, such as, for example, a keyboard or touch interface. Mobile devices 101-103 are typically a mobile computing device that can provide various utilities, such as communication, entertainment, navigation, information management, and basic computing functions. Mobile devices 101-103 can include, but are not limited to, cellular phones including smartphones, tablet computers, personal computers, digital assistants, portable media viewers and game consoles. Mobile devices 101-103 can also include general purpose computers, such as but not limited to a laptop or other portable personal computer. Mobile devices 101-103 can be coupled to mobile device management server 110 over a wired connection, a wireless connection or any combination thereof.

Mobile device management (MDM) server 110 is a server computer connected to network 120 that executes software to provide security, monitoring, and management across the deployed mobile devices 101-103. An enterprise or service provider can use MDM server 110 to manage all of its deployed mobile devices. In traditional MDM servers 110, an administrator will use admin access console 112 to set policies that are then distributed to mobile devices 101-103 to control the behavior of the mobile devices 101-103. These policies control the behavior of mobile devices with respect to access control, resource and application utilization, operational characteristics, monitoring and logging. The policy ensures that mobile devices 101-103 conform to particular network or enterprise device usage policy, or operate in accordance with defined operational constraints or principles. In the traditional MDM model these policies remain static and mobile devices 101-103 execute a client-side policy management process (or device agent) that ensures the policy is installed and is enforced.

MDM server 110 can also be provided with user access privileges from user access privileges server 130 that contains privileges associated with each of the users of mobile devices 101-103. User access privilege server 130 contains information privileges of the user that can be used to select a policy for the user's mobile device 101 and select what type of data and applications a user's mobile device 101 should be allowed access. Information privileges can include whether a user can access privilege information 132 stored by the organization. User access privilege server 130 can separate users into groups with each group having certain access privileges. For example, user access privilege server 130 can contain information privileges that provide that a user is a member of the enterprise sales force. MDM server 110 can use the information privileges of this user to provide policy information that allows the user's mobile device 101 to run the enterprise sales application and connect to the corporate database containing sales information, such as sales history or potential sales leads. User access privileges server 130 can be a lightweight directory access protocol server or an active directory server, or obtain data from these types of servers. In this context, information privileges can be obtained from domain or user group information stored by these servers. In some embodiments, information privileges can be related to a job title, a job level in the organizational hierarchy, a security clearance level, or similar information that can be used to limit access to privileged information 132.

Privileged information 132 can include any type of data that is not public and that can be provided to users of mobile devices 101-103 throughout the organization. Privileged information 132 can be secured through limited network access (e.g. privileged information can only be accessed over a VPN connection or on local network of storage of privileged information 132). Privileged information 132 can also be limited by only being accessible using a certain application executing on mobile devices 101-103. Access to privileged information 132 can also be limited through the use of encryption/decryption keys either stored or accessible by mobile device 101-103 that can be controlled by MDM server 110 or user access privileges server 130.

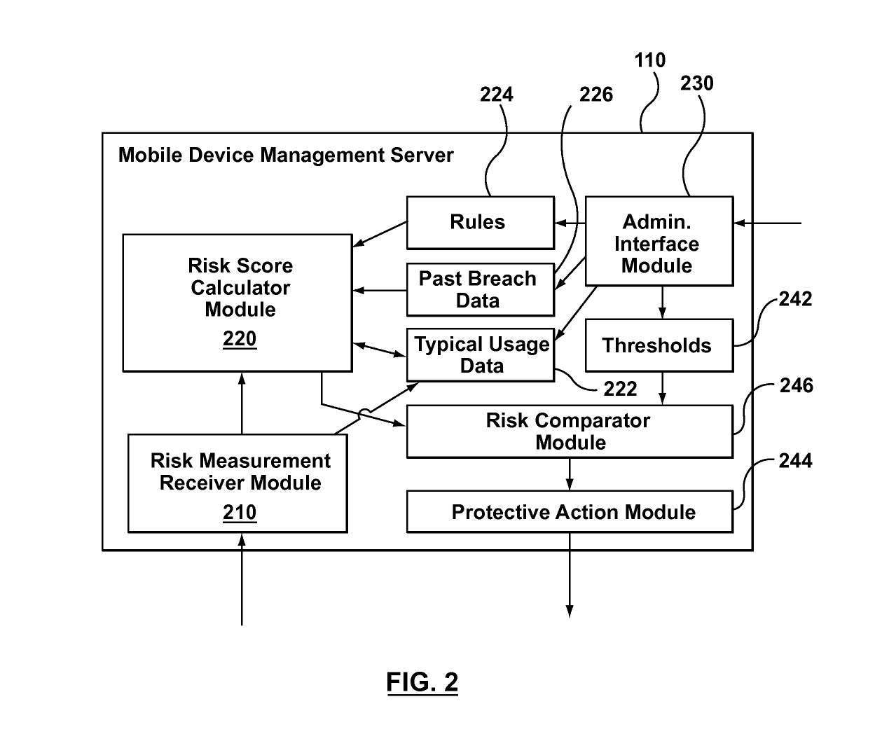

Referring now to FIG. 2, shown is a block diagram of modules of mobile device management server 110 for determining security risk of mobile devices 101-103. Modules can be software instructions stored in computer memory of a network connected server to be executed by a processor. MDM server 110 can receive risk measurements from mobile devices 101-103 that MDM server 110 uses to calculate a risk score to determine whether protective action should be taken by one of the mobile devices 101-103.

Risk measurement receiver module 210 receives risk measurements from mobile devices 101-103 over network 120. Risk measurement receiver module 210 provides an interface that is accessible to network 120 from mobile devices 101-103. A risk measurement can identify the sending mobile device 101-103 and measurement of any one of a number of factors that are obtained from sensors on the mobile device 101-103. Risk measurements can also be provided in a report that is periodically sent from mobile devices 101-103.

An on-device agent executing on each mobile device 101-103 is constantly monitoring hardware and software sensors of the device to transmit an update to risk measurement receiver module 210 on the changing environment or operating context of mobile devices 101-103. In some embodiments, on-device agent can send a periodic update with risk measurements.

Hardware sensors of mobile devices 101-103 record risk measurements in the physical environment. Examples of hardware sensor measurements can include ambient light from a light sensor, temperature from a temperature sensor, or time. Software sensors of mobile devices 101-103 record risk measurements in the software environments. Examples of software sensor measurements can include the version of the operating system, running applications or active processes, or whether someone entered a wrong password 5 times.

Risk measurements can be either static or dynamic. Static risk measurements are those that do not change with the environment and remain the same if taken at a different place or time. These measurements are persistent regardless of the environment or power cycling the device. Conceptually, static risk measurements are the factors that remain unchanged during typical operation of the mobile device. Examples include installed applications, permission of applications installed, author signing key of the installed applications, operating system version, whether the device has undergone a successful privilege escalation attack (e.g. jailbroken), the owner of the device, or the user identification number of the device.

Dynamic risk measurements are the dual of static risk measurements. These risk measurements record the environment or operating context in which the device is running that are subject to change from moment to moment without making persistent changes to the mobile device. Dynamic risk measurements can include risk measurements taken from the mobile device hardware and software sensors, and can also include risk measurements based on the user of the mobile device that occur on the server side. Some example dynamic risk measurements can include network connections, amount of free memory, CPU temperature, information privileges GPS location, current roaming carrier, currently running applications, current date and time, or the information privileges of the user. Information privilege level of the user of the device can be related to the user's job title and provides a risk measurement that constitutes a risk footprint for the corresponding job title. This can be considered a dynamic risk measurement because it can be changed on the server without awareness by the mobile device. The risk history of the device owner can also be a dynamic factor, such as whether the user has a habit of engaging in risky behaviors, or is often approaching or surpassing risk thresholds. The privileges of the owner of the device, such as the type of confidential information the owner has access to can also be considered a dynamic risk factor.

Risk score calculator module 220 evaluates these dynamic and static factors received from each of mobile devices 101-103 against rules 224, past breach data 226 and typical usage data 222 to provide a risk score. The dynamic and static risk factors are combined in order to obtain an overall risk score. Risk score calculator module 220 can update the risk score upon receiving risk measurements from the corresponding mobile devices. In some cases, MDM server 110 may be unable to obtain dynamic risk measurements, such as when the device is outside of network coverage, and risk score calculator module 220 can only update the risk score based on static risk measurements.

Risk measurement receiver module 210 will process received risk measurements to allow them to be processed by risk score calculator module 220. This can involve storing received risk measurements in a database or other data structure that allows risk score calculator module 220 to access all recent risk measurements for a particular mobile device in order to perform a risk calculation.

In some embodiments, risk measurement can also be received from another server, such as, for example, an enterprise server that contains user access privileges. Risk measurement receiver module 210 can collect privilege information from user access privileges server 130 to obtain updated information on the users of the mobile devices 101-103. As noted above, this privilege information can include, but is not limited to, job title, job level in organizational hierarchy, and security clearance level. This privilege information can be used by risk score calculator module 220 in calculating a risk score. Collecting risk measurements that change without the device's knowledge must be measured on the server side making it an environmental, dynamic risk measurement.

Risk measurement receiver module 210 can also store risk measurements associated with mobile devices 101-103 that can be used to create typical usage data 222. Risk measurement receiver module 210 can periodically store risk measurements to create typical usage data 222. Typical usage data 222 can be based on users in the same user group, level of the organization, the particular user or device, or any combination of the preceding examples.

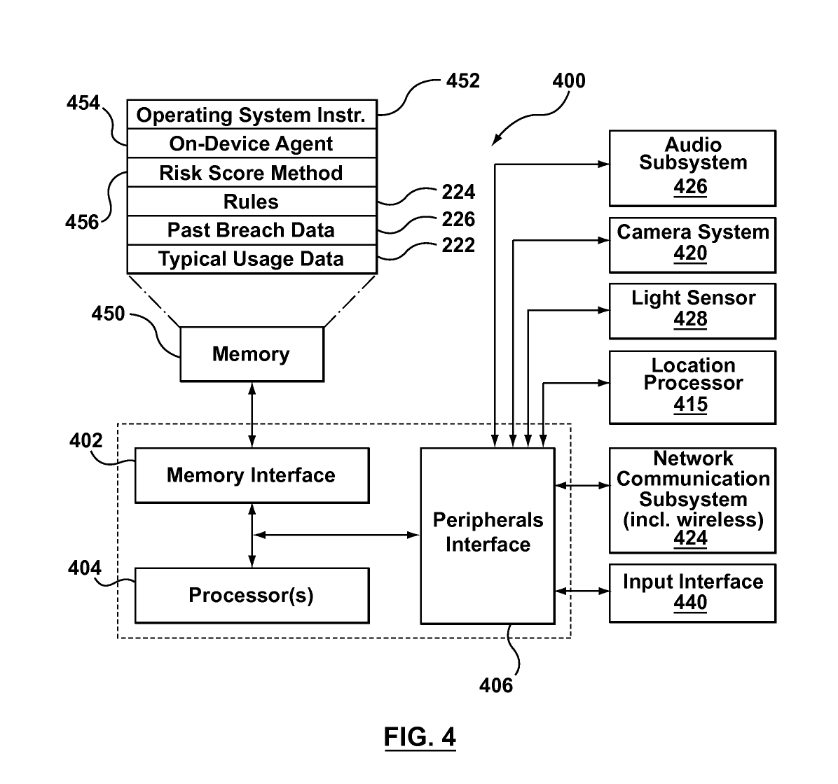

Typical usage data 222 can include data from both hardware and software sensors of mobile devices 101-103 and can include both dynamic and static factors. Hardware sensors measure something in the physical environment, such as light, temperature, time, or location, for example. Some examples of particular hardware sensors are provided with respect to FIG. 4. Software sensors measure the software state on the mobile device, such as operating system version, running or installed applications, user identification of the mobile device, memory or network usage, or the presence of malware.

Typical usage data 222 can be used by risk score calculator module 220 to adjust a risk score for a mobile device. Risk score calculator module 220 can determine whether the current operation of a mobile device is correlated with typical usage data 222. Correlation factors can include, but is not limited to, time and location. For example, typical usage data 222 can include date, time and location data that can be used to determine the typical geographic area that the mobile device is located at particular dates and time. For example, typical usage data 222 could include that on weekdays between 9 A.M. and 5 P.M. the mobile device is typically located on-site. Other example typical usage data 222 can include what applications and network services are used by a particular mobile device that can also be correlated with date and time. For example, a mobile device may typically use a VPN service only during working hours when the mobile device is located off-site or during early evening hours when the mobile device is located off-site.

In other embodiments, typical usage data 222 can be provided for a user of mobile devices 101-103 based on the worker's privileges, title, time zone and working hours, for example. In some embodiments, this type of typical usage data 222 can be provided as a baseline that is modified based on actual usage data received at risk measurement receiver module 210.

Risk score calculator module 220 can use a number of different risk measurements that can be combined in order to calculate a risk score for mobile devices 101-103. Risk measurements can be evaluated based on any one or the combination of: typical usage data 222, rules 224, and past breach data 226.

MDM server 110 can include a number of rules 224 that can be used to evaluate the received risk measurements. Rules 224 can be defined as conditional statements to evaluate one or more risk measurements and take a corresponding action to adjust the risk score for the mobile device. Static and dynamic risk measurements received from mobile devices 101-103 can be evaluated against rules 224 by risk score calculator module 220 to determine how to adjust the risk score associated with each of mobile devices 101-103. A sample rule could provide that if a mobile device has an on-site geographic location then the risk score is adjusted downwards.

MDM server 110 can include default rules or rules 224 can be defined or adjusted by an administrator that obtains access through administrator interface module 230. Rules 224 can be defined based on an administrators experience and organization requirements. In contrast with typical usage data 222 and past breach data 226, rules 224 cannot be reliably learned by a computer and are typically set by an administrator. Rules 224 can be used to adjust the risk score based on, for example, the security level of information accessible by a mobile device, security level of an individual user, geographic location, and applications present on the mobile device.

Rules 224 can rely on risk measurements from hardware and software sensors on mobile devices 101-103. For example, a location processor of a mobile device 101 can provide a geographic location, for example, from a GPS receiver or a Wi-Fi positioning system, such as that provided by Skyhook Wireless of Boston, Mass., that can be used for geolocation-based rules. Geolocation-based rules can adjust the risk score based on mobile device proximity to one or more specific locations, such as known secure and insecure locations. Geolocation-based rules can also use a geofence (i.e. a virtual perimeter for a real-world geographic area) to determine whether a mobile device is within or outside the perimeter of the geofence. Geolocation-based rules can be created by identifying locations, for example by country, region, address, or GPS coordinates, and providing an associated risk level for the location (e.g. using a scale from very insecure to very secure). In some embodiments, some geolocation-based rules can be updated on a periodic basis from a central server as a service from the MDM software vendor that indicate regions of mobile device security risk around the world.

Example geolocation-based rules can include adjusting the risk score to indicate increased risk (e.g. increasing the risk score by 10000) if the GPS location of the mobile device is located within 500 feet of an insecure location, such as an enemy base. An additional rule could be used to adjust the risk score to indicate decreased risk (e.g. decreasing the risk score by 1000) if the GPS location of the mobile device is within 100 feet of a secure location. Another rule could be used to adjust the risk score to indicate increased risk if the GPS location of the mobile device is in a geographic region that is known for exploiting mobile devices.

Rules 224 can be based on risk measurements from software sensors that can be used to adjust the risk score for any one of mobile devices 101-103. For example, one of rules 224 can increase the risk score associated with the device if a risk measurement provides evidence that known malware is installed on the mobile device. The presence or absence of an application on the mobile device storage or in active memory, or the author signing key of applications that are installed can also be used by rules 224 to adjust the risk score. For example, rule 224 can increase the risk score if a mobile device 101-103 has an application installed that is signed by a known malware author, and the risk score can be further increased if said application is currently executing. Software sensors of the mobile devices 101-103 can monitor active processes and the operating system, such as but not limited to the operating system version or loaded kernel modules, that can allow risk score calculator module 220 to adjust the risk score using rules 224 based on these risk measurements. For example, if anyone of mobile devices 101-103 is running an operating system version that has known security exploits the risk score associated with the mobile device can be increased.

Rules 224 can also be based upon how long a mobile device 101 has not been in contact with MDM server 110. In some embodiments, a rule can be used to trigger an alert associated with a risk threshold when a device cannot be reached. In other embodiments, rules 224 can gradually increase the risk score while the mobile is not in contact with MDM server 110. The longer mobile device 101 is unreachable, the higher the risk score.

Rules 224 can also be based upon information privilege using the job title or position in an organizational hierarchy of the user of mobile devices 101-103. For example, one of rules 224 can determine if the user of mobile device 101 is promoted from manager to vice president then the risk score can be increased because the vice president has access to more sensitive information. Rules 224 can also be based upon user permissions to certain privileged information 132. For example, risk score can be increased if a user is granted access to highly sensitive information, such as patient health information or enterprise trade secrets.

Risk score calculator module 220 can also evaluate risk measurements received from risk measurement receiver module 210 against past breach data 226. The past breach data 226 can include patterns of risk measurements from previous security breaches (including attempted security breaches) that can be used to evaluate risk measurements from mobile devices 101-103 to adjust the risk score of each mobile device.

Risk score calculator module 220 can determine the correlation of risk measurements received from mobile devices 101-103 with that of known security breaches. An explicit rule does not need to be created by an administrator, but to facilitate detection of security breaches the administrator associates historical risk measurements with an actual breach event. Past breach data 226 can also be supplied by a server remote from the MDM server 100 that is operated by the MDM software vendor or another service provider.

Risk score calculator module 220 can use past breach data 226 as an administrator-defined mapping from past security breaches, attempted security attacks, and data loss incidents. Risk score calculator module 220 can weight by age to provide more recent security breach data with a higher associated risk score. For example, an enterprise can classify security breaches into 100 levels to provide 100 base scores that are weighted by age for each of these security breaches within past breach data 226.

An example of using past breach data 226 to adjust the risk score could include risk score calculator module 220 increasing the risk score if the mobile device is located in a country where a number of previous breaches have occurred. Past breach data 226 can reflect the severity of the security risk by the number of security breaches that are associated with a particular risk measurement. A certain risk factor in past breach data 226 may have an increased security risk, and thus greater impact on increasing the risk score if it is highly correlated with a number of past security breaches. Risk score calculator module 220 can evaluate the severity of the risk for a certain risk measurement based on its frequency of occurrence within past breach data 226. For example, if multiple security breaches have occurred in the same country then the risk score calculator module 220 can take this into account to increase the risk score adjustment relative to a country that has had only a few security breaches.

Past breach data 226 can also be used by risk score calculator module 220 to determine which combination of risk measurements are highly correlated with a security breach. For example, a certain country may be prone to using a known exploit when a mobile device is using a certain wireless carrier and a certain version of the mobile device operating system. Risk score calculator module 220 can evaluate the correlation of multiple risk measurements with those of past security breaches in past breach data 226 to increase the risk score proportionately to the number of risk measurements are correlated with past security breaches. For example, if a mobile device is located in the aforementioned country and running the aforementioned operating system version then risk score calculator module 220 would increase the risk score but if the mobile device was also using the aforementioned wireless carrier then the risk score would be increased to reflect this greater risk. In these scenarios the risk score adjustments is not simply cumulative of the effect of each individual risk measurement but rather reflects the increased security risk from having a number of risk factors present (i.e. reflects the correlation of the combination of factors with past security breaches).

Risk score calculator module 220 can also use typical usage data 222, described above, to detect anomalies in the operation of mobile devices 101-103. Operation of a mobile device outside of a normal usage pattern can identify an unforeseen potential risk (e.g. not associated with past security breaches). For example, risk score calculator module 220 can increase the risk score if the mobile device is not being operated at its typical time and location, such as at the office on a weekday during working hours as established by typical usage data 222.

Risk comparator module 240 receives the calculated risk score from risk score calculator module 220 and compares the risk score to one or more thresholds 242 to determine whether protective action module 244 should instruct a mobile device to take a protective action. In some embodiments, protective action module 244 can also alert administrators or set alarm conditions viewable in the administrative interface module 230. Thresholds 242 can include risk scores that are associated with a certain protective action that can take place. Thresholds 242 can include multiple thresholds that are each associated with progressively more severe protective actions. For example, when the risk score is greater than 1,000, alert the administrator; when the risk score is greater than 10,000, lock access to privileged information on the mobile device; and when the risk score is greater than 100,000, wipe the mobile device and freeze the user's accounts on the enterprise servers. Using progressive thresholds allows MDM server to provide a protective action that corresponds to the perceived security threat measured by the risk score. Rather than simply disabling the mobile device (e.g. lock or wipe) the progressive thresholds allow the mobile device to remain somewhat useful to the user while still protecting enterprise data or infrastructure.

Protective actions module 244 can provide protective management commands to mobile devices 101-103 that instructs the mobile device to take a protective actions. Protective action module 244 can also provide protective management commands to other systems on the server side to instruct the server to take protective action. For example, protective actions module 244 could provide instructions to user access privileges server 130 to revoke or alter a user's access privileges if a certain risk score is exceeded. This could include revoking user credentials for accessing a VPN or privileged information 132. A protective action could also downgrade a user's privileges so that the user can access some systems but not those requiring higher levels of security. This could involve removing a user from an access group in user access privileges server 130.

Protective command instructions can include directing the mobile device to lock the device such that the information on the mobile device is made inaccessible. Another protective action can include disabling network access to privileged information. This can be performed by disabling network interfaces altogether, but is more preferably accomplished by disabling network access to privileged information, such as by disabling VPN connection (or credentials on the server side) or by disabling applications that can be used for accessing privileged information.

Administrative interface module 230 can be provided to allow an administrator to configure the operation of MDM server 110. This can include configuring rules and the severity of the associated risk, and also the severity of risk associated with past breach events or typical usage data. Administrative interface module can also provide an interface for receiving data from remote sources that can be used to configure rules, historical data and any associated risk severity. This can include data provided from a 3^{rd} party or the MDM software vendor to provide updated lists of applications, authors, locations, breach scenarios, usage patterns, etc. and associated risk severity that can be used to update rules 224, past breach data 226 and typical usage data 222 in order to provide updated data to risk score calculator module 220 in providing a risk score.

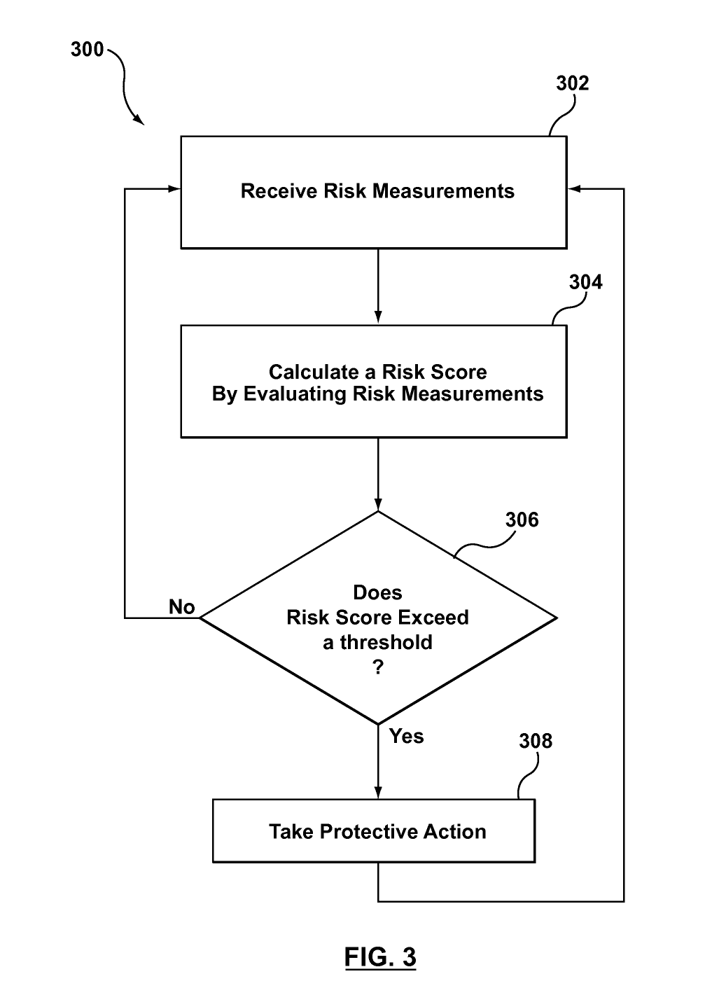

Referring now to FIG. 3, a flow chart of a method 300 for determining a security risk of a mobile device is shown. Method 300 can be performed by MDM server 110 to provide device management to mobile devices 101-103. MDM server 110 can include a processor and memory, as illustrated in FIG. 4, and can be configured to perform method 300.

First, at step 302, risk measurements are received. Risk measurements are transmitted by mobile devices 101-103 to provide information collected by an on-device agent that monitors hardware and software sensors of the corresponding mobile device. In the embodiment shown in FIG. 2, risk measurement receiver module 210 can be configured to perform step 302. Risk measurements can be received periodically or when an on-device agent detects a change to a risk measurement and transmits one or more of the risk measurements to the MDM server 110. In some embodiments, failure to receive a periodic risk measurement can result in a calculated increase to the risk score in step 304 or directly to taking a protective action at step 308. The risk score can also be progressively increased as the number of periodic risk measurements are missed for a mobile device.

Next, at step 304, a risk score is calculated by evaluating the received risk measurements from 302. The risk score for a mobile device is constantly being calculated and updated based on the received risk measurements. Risk score calculating step 304 can be an adjustment to a previously calculated risk score based on recently received risk measurements. In the embodiment shown in FIG. 2, risk score calculator module 210 can be configured to perform step 304 using any of rules 224, past breach data 226 and typical usage data 222. In step 304 calculating a risk score can include evaluating received risk measurements against rules to adjust the risk score of the corresponding mobile device. The risk measurements can be further evaluated against past breach data and typical usage data.

The risk score calculated in step 304 is then compared to at least one threshold in step 306, and preferably, to a number of thresholds that are each associated with progressively more severe protective actions. If a threshold is exceeded then protective action is taken in step 308 that is associated with each of the exceeded thresholds.

If a threshold is not exceeded or protective action is taken in step 308, method 300 repeats at step 302. Method 300 continuously receives risk measurements 302 and calculates risk scores 304 so that even after a protective action has been taken, if the mobile device enters a more hostile environment (as noted by received risk measurements). If the adjusted risk score exceeds a higher threshold, a corresponding, typically more severe, protective action can be taken in step 308. This more severe protective action can be taken in combination with previous protective actions or replace the current protective action.

In some embodiments, a risk score can be adjusted by first evaluating risk measurements against rules in step 304 and then comparing to a threshold in step 306 prior to evaluating risk measurements against typical usage data or past breach data. For example, some embodiments can have a minimum risk score threshold that must be exceeded before risk measurements are evaluated against either typical usage data or past breach data in steps 304 and 306 to provide efficient use of MDM server resources.

In some embodiments, the risk score and associated risk measurements can be fed to a learning system that includes a database of past results that is used to improve accuracy of future anomaly detection. If a risk measurement or combination of risk measurements are confirmed to be an actual risk, then the learning system can apply a corresponding increased weight to these risk measurements. For example, if a user is found to be habitually installing questionable software, then this can be confirmed to be an actual risk and every new installation of questionable software can be learned because it contains concrete, new information that can be used in adjusting the risk score of the mobile device.

FIG. 4 is a block diagram of an exemplary computer architecture 400 for the mobile devices 101-103 or MDM server 110. Mobile devices 101-103 and MDM server 101 can each implement the exemplary computer architecture 400 but the individual architectures can be distinguished based on which peripherals are coupled to peripheral interface 406. For example, mobile devices 101-103 can include an audio subsystem, a camera system, a light sensor and location processor that would not be necessary for MDM server 110. Exemplary computer architecture 400 can include memory interface 402, one or more data processors, image processors and/or central processing units 404, and peripherals interface 406. Memory interface 402, one or more processors 404 and/or peripherals interface 406 can be separate components or can be integrated in one or more integrated circuits. The various components in mobile devices 101-103, for example, can be coupled by one or more communication buses or signal lines.

Sensors, devices, and subsystems can be coupled to peripherals interface 406 to facilitate multiple functionalities. Mobile device embodiments of exemplary computer architecture 400 can have a location processor 415 (e.g., GPS receiver) that can be connected to peripherals interface 406 to provide geopositioning. Mobile devices can also include light sensor 428 that can sense ambient light levels. Additional sensors can include the system clock that can be used to evaluate risk as some times are riskier than others. Some embodiments can also include a pressure sensor that can be used along with GPS to determine altitude. Acceleration and orientation sensors can also be used to determine the orientation of the device. For example, the risk score can be adjusted based upon whether the screen of mobile devices is facing upwards.

Camera subsystem 420 can include an optical sensor, e.g., a charged coupled device (CCD) or a complementary metal-oxide semiconductor (CMOS) optical sensor, that can be utilized to facilitate camera functions, such as recording photographs and video clips. The light sensor can be used to help determine if a mobile device is indoors or outdoors.

Communication functions can be facilitated through network communication subsystems 424 that provides for communication over public network 120. Network communication subsystems 424 can include radio frequency receivers and transmitters and/or optical (e.g., infrared) receivers and transmitters. The specific design and implementation of the network communication subsystem 424 can depend on the communication network(s) over which a mobile device or MDM server is intended to operate. For example, a mobile device can include network communication subsystems 424 designed to operate over a GSM network, a GPRS network, an EDGE network, 3G/4G networks (UMTS/LTE), a Wi-Fi or WiMax network, and a Bluetooth™ network. MDM server 110 would typically operate in a data center that uses wired Ethernet to connect to public network 120.

Audio subsystem 426 can include a coupled to speaker and microphone to facilitate voice-enabled functions, such as voice recognition, voice replication, digital recording, and telephony functions. Audio subsystem 426 can also be used to monitor environmental factors. Microphone sensors can be used for risk measurements based on recognized sound sources, whether it may be windy or noisy, voice recognition of people in the room, and other sound related factors.

Input interface 440 can be used for user interaction with exemplary computer architecture 400. Input interface 440 can include a touch screen controller and/or other input controller(s). Touch-screen controller can detect contact and movement or break thereof using any of a plurality of touch sensitivity technologies, including but not limited to capacitive, resistive, infrared, and surface acoustic wave technologies, as well as other proximity sensor arrays or other elements for determining one or more points of contact.

Other input devices can also be coupled to input interface 440, such as a keyboard, one or more buttons, rocker switches, thumb-wheel, infrared port, USB port, and/or a pointer device such as a stylus. The one or more buttons (not shown) can include an up/down button for volume control of speaker and/or microphone.

Memory interface 402 can be coupled to memory 450. Memory 450 can include high-speed random access memory and/or non-volatile memory, such as one or more magnetic disk storage devices, one or more optical storage devices, and/or flash memory (e.g., NAND, NOR). Memory 450 can store operating system 452, such as Darwin, RTXC, LINUX, UNIX, OS X, WINDOWS, or an embedded operating system such as VxWorks. Operating system 452 may include instructions for handling basic system services and for performing hardware dependent tasks. In some implementations, operating system 452 can include a kernel (e.g., UNIX kernel).

In mobile device embodiments of exemplary computer architecture, memory 450 can store application instructions for on-device agent 454 that configures processor 404 to collect risk measurements from data collected through peripheral interfaces (e.g. hardware sensors, for example, light sensor 428 and location processor 415) and software sensors (e.g. state or context of operating system 452 and other active processes in memory 450). On-device agent 454 can further include instructions to configure processor 404 to transmit the collected risk measurements through network communication subsystem 424 to MDM server 110.

In MDM server embodiments of exemplary computer architecture, memory 450 can store risk score method instructions 456 to configure processor 404 to perform method 300 for determining a security risk of a mobile device from received risk measurements. Risk score method instructions 456 can configure processor 404 to receive risk measurements and transmit protective actions through network communication subsystem 424. Memory 450 can also contain rules 224, past breach data 226 and typical usage data 222 that are accessed by processor 404 in calculating risk scores and updating historical data (e.g. past breach data 226 and typical usage data 222). Modules illustrated in FIG. 2 can be implemented as risk score method instructions 456.

On-device agent 454 can provide a method for providing mobile device security to maintain a connection with a mobile device management server 110. On device-agent 454 can enforce one or more timeout rules that specify a timeout period and has any associated protective actions that are to be taken if the mobile device fails to contact the MDM server 110. Timeout rules can be a pre-defined, simplified set of rules that can be sent by MDM server 110 to the mobile device at provision time, and the mobile device will be able to take action autonomously if the mobile device cannot contact the MDM server 110. The timeout rule can be setup upon provisioning of the mobile device for initial operation. In other embodiments, the timeout rule can be provided and updated by the MDM server 110. The timeout period of the timeout rule can specify a time period within which the mobile device should have contacted the MDM server 110. The timeout period is preferably much greater than the period risk measurement reporting period enforced by on-device agent 454. Mobile device 101 can attempt to contact the MDM server 110 either as part of providing risk measurement reporting or as an additional attempt to contact the MDM server 110 to avoid the protective action associated with the timeout rule. For example, if the mobile device has not made contact with MDM server 110, then on-device agent 110 can attempt to contact MDM server using network communication subsystem 424 prior to the expiry of the timeout period.

The protective action associated with the timeout rule should be performed if the mobile device is unable to make contact with the MDM server 110. Failure to contact the MDM server can mean that the mobile device is at a higher security risk and can potentially be compromised. The mobile device preferably has network access during the timeout period and is capable of making network connections with MDM server (e.g. mobile device has internet access).

Contact with MDM server 110 can be an active network connection with the MDM server 110 or receipt of an acknowledgement from the MDM server 110. Preferably, the acknowledgement uses some type of encryption or challenge-response algorithm to prevent spoofing an acknowledgement to the mobile device.

Adjustments to the risk score have been described as increasing to represent an increased threat or security risk, and is not necessarily related to the numerical value of the risk score. The same holds for the description of the thresholds and exceeding a threshold represents exceeding a certain level of calculated risk. Alternatively, some embodiments can have an initial secure risk score and decrease the risk score according to an associated threat or security risk. Adjusting the risk score can either increase/decrease the risk score by a certain numerical value or can also scale the risk score if the effect of the security risk is multiplicative of the other risks. Risk score calculator module 220 can combine the effects of some factors being additive and other being scaling (i.e. multiplicative).

### Exemplary Risk Score Calculation Cases

The following example risk score calculations are provided as an example of the operation of the above described embodiments. In each example, on-device agent 454 collects a number of risk measurements that are provided to MDM server 110 and MDM server further collects other risk measurements related to the mobile device or the user of the mobile device. Risk score calculator module 220 evaluates the received risk measurements to adjust the risk score.

In a first example, the following risk measurements are evaluated by risk score calculator module 220:

1. An application is installed on the mobile device that is authored by a rogue author. A rogue author can be identified as part of past breach data 226 or as part of rules 224 that can identify a rogue author from data provided by an external source.
2. Another installed application has network permissions to access privileged information in the enterprise.
3. The user of the mobile device has been granted a high level of information privileges that allow access to high security enterprise information.
4. The mobile device is making network connections to network addresses located in a rogue country. A rogue country can be used to identify and adjust the risk score similar to a rogue author.
5. The mobile device is operating during normal business hours as determined by rules 224 and system clock of the mobile device.

Based on the above risk measurements, risk score calculator module 220 will calculate the risk score. Some factors can have increased effect on risk score, such as risk measurements 1 and 4 above. The calculated risk score will then be compared to one of the thresholds 242 to determine the risk level and the appropriate protective action. In this case, the risk level may be determined to be high and the protective action will limit access to the privileged information available from the mobile device.

In a second example, the following risk measurements are evaluated by risk score calculator module 220:
1. The mobile device is connected to a rogue carrier; and
2. The user of the mobile device has been granted a high level of information privileges that allow access to high security enterprise information.

Risk score calculator module 220 will calculate the risk score and compare the risk score to the thresholds 242 to determine the risk level and the appropriate protective action. In this case, the risk level may be determined to be high based on factors 1 and 2, and the protective action can enable an “airplane mode” that disables the mobile device from using network communication subsystem 424.

While the exemplary embodiments have been described herein, it is to be understood that the invention is not limited to the disclosed embodiments. The invention is intended to cover various modifications and equivalent arrangements included within the spirit and scope of the appended claims, and scope of the claims is to be accorded an interpretation that encompasses all such modifications and equivalent structures and functions.

1. A method for determining security risk of a mobile device, the method comprising:
receiving risk measurements from at least one mobile device;
calculating a risk score by evaluating the risk measurements based on rules;
determining whether the calculated risk score exceeds a threshold; and
taking a protective action upon the risk score exceeding the threshold.

2. The method of claim 1, wherein calculating risk score further comprises correlating the risk measurements with a past security breach.

3. The method of claim 2, wherein the past security breach is associated with historical risk measurements.

4. The method of claim 2, wherein calculating risk score further comprises correlating the risk measurements with typical usage risk measurements.

5. The method of claim 4 further comprising periodically storing risk measurements from the at least one mobile device to determine the typical usage risk measurements.

6. The method of claim 1, wherein the protective action is sending an administrator notification.

7. The method of claim 1, wherein the protective action is sending a protective management command to the at least one mobile device.

8. The method of claim 1, wherein the protective management command instructs the at least one mobile device to prevent access to privileged information

9. The method of claim 1, wherein the protective management command instructs a user access privilege server to disable network access to privileged information from the at least one mobile device.

10. The method of claim 1, wherein the protective management command instructs the at least one mobile device to delete data from the at least one mobile device.

11. The method of claim 1, wherein the protective action is disabling the at least one mobile device user account in a user access privilege server.

12. The method of claim 1 further comprising collecting a portion of the risk measurements from a user access privileges server.

13. The method of claim 13, wherein the portion of the risk measurements comprises a job title of a user of the at least one mobile device.

14. A method for determining security risk of a mobile device, the method comprising:
obtaining risk measurements from mobile device sensors; and
transmitting the risk measurements to a mobile device management server.

15. The method of claim 14 further comprising detecting a change in at least one of the risk measurements and wherein transmitting the risk measurements upon detecting the change.

16. The method of claim 14 further comprising receiving a protective management command in response to transmitted risk measurement that instructs the mobile device to limit access to privileged information.

17. The method of claim 14, wherein the sensors comprise any one of a hardware sensor and a software sensor.

18. The method of claim 14, wherein the risk measurements are any one of static and dynamic.

19. The method of claim 18, wherein the static risk measurements comprise any one of: installed applications; installed application permissions; author signing key of installed applications; operating system version; user identification; owner of the mobile device; and malware indicators.

20. The method of claim 18, wherein the dynamic risk measurements comprise any one of: network connections; available memory; CPU temperature; GPS location; current roaming carrier, currently running applications; current date and time; and information privileges of a user of the mobile device.

21. A method for providing mobile device security, the method comprising:
receiving a timeout rule that specifies a timeout period and a protective action from a mobile device management server;
attempt to contact the mobile device management server within the timeout period; and
perform the protective action upon failure to contact the mobile device management server within the timeout period.

22. The method of claim 21, wherein the timeout rule is received during provisioning of the mobile device.
